(19) United States
(12) Patent Application Publication
(10) Pub. No.: US 2013/0192939 A1
(43) Pub. Date: Aug. 1, 2013

(54) BRAKE SPRING FOR A DISC BRAKE

(71) Applicants: Lakshmi Narayanan V., Farmington, MI (US); William Curtis Ross, Roseville, MI (US)

(72) Inventors: Lakshmi Narayanan V., Farmington, MI (US); William Curtis Ross, Roseville, MI (US)

(73) Assignee: AKEBONO CORPORATION (NORTH AMERICA), Elizabethtown, KY (US)

(21) Appl. No.: 13/360,061

(22) Filed: Jan. 27, 2012

(51) Int. Cl. F16D 65/00

(52) U.S. Cl. 188/73.38

(57) ABSTRACT

A brake spring comprising: one or more hooking portions for attaching the brake spring to an arm of a support bracket, two or more locking tabs; and at least one first flexible arm connected to and extending from the hooking portion, wherein the at least one first flexible arm folds back so that at least a portion of the first flexible arm extends along a surface of the hooking portion, wherein the at least one first flexible arm extends from the hooking portion so that the at least one first flexible arm abuts a contact surface of a caliper body and provides forces to restrain the caliper body.

### FIELD

The present teachings generally relate to an improved brake spring for a disc brake and more particularly to an improved brake spring for a disc brake that provides both radial and axial forces.

### BACKGROUND

The present teachings are predicated upon providing an improved disc brake system (or caliper brake system) for use with vehicles. For example, the brake caliper may be used with almost any vehicle (e.g. car, truck, bus, train, airplane, or the like). Alternatively, the caliper may be integrated into assemblies used for manufacturing or other equipment that require a brake such as a lathe, winder for paper products or cloth, amusement park rides, or the like. However, the present teachings are most suitable for use with a passenger vehicle (i.e. a car, truck, sports utility vehicle, or the like).

Typical, disc brake systems include a support bracket, two more brake pads, a caliper body (e.g., a suspended caliper body), and a rotor. The at least two brake pads (friction pads) are mounted via two or more pins and located adjacent to the support bracket and/or attach directly to the support bracket arms so that the brake pads move axially towards and away from the rotor. The disc brake system may include an anti-rattle spring that provides some level of forces (radial/vertical, axial, or both) between the support bracket and the caliper such that when the brake is not in use, any caliper movement is limited and any rattle is minimized. These springs also may function to retract the body after brake applications so that intended running clearances between the brake pads and the rotor could be maintained. Some known anti-rattle spring designs connect and move with the caliper body when the brakes are applied, and as the lining of the brake pads wear. These anti-rattle clips (or springs) do not provide an intended axial force or stiffness to keep the housing (or body) at intended positions in relation to the rotor as the linings and rotor wear. This is due to the long body construction of the clips where controlling the intended stiffness in two or more directions is difficult. Additionally, during maintenance to the braking system (i.e., changing the brake pads, the rotor, or both) these clips may need to be replaced, which may result in the spring being bent, damaged, installed improperly, plastically deformed, a reduction in the potential force of the spring, or a combination thereof. In some known anti-rattle clip designs the axial load changes substantially as the lining of the brake pads and rotor wear. It would be attractive to have a brake spring that slips against the caliper so that the brake spring applies or reacts to a substantially constant axial force as the lining of the brake pads wear. It would also be attractive to have a discrete brake spring on each side of the brake assembly so that the forces applied to each side of the brake assembly are independent of the force applied to the opposing side of the brake assembly.

Examples of some anti-rattle springs are disclosed in U.S. Pat. Nos. 3,710,896; 4,186,824; 4,194,597; 4,410,068; 4,607,728; 4,901,825; 5,067,594; 6,179,095; 6,644,444; and 6,971,486, also U.S. patent publication No. 2004/0108176, all of which are expressly incorporated herein by reference for all purposes.

It would be attractive to have a braking system that provides an improved brake spring design that generates appropriate radial force, axial force, or both so that the caliper housing is adequately restrained at all times and to keep the body at the intended positions in relation to the rotor before and after brake applications. What is further needed is a brake spring that allows for the caliper housing to adjust so that as the brake pads, the rotor, or both wear, the brake spring and the caliper housing remain in substantial alignment and the forces exerted by the brake spring is substantially constant throughout the brake pad life, rotor life, or both. What is further needed is a brake spring where the brake spring applies a force to one side of a caliper that is independent of the force applied to the opposing side of the caliper housing.

### SUMMARY

The present teachings meet one or more of the present needs by providing: a brake spring comprising: one or more hooking portions for attaching the brake spring to an arm of a support bracket; two or more locking tabs; and at least one first flexible arm connected to and extending from the hooking portion, wherein the at least one first flexible arm folds back so that at least a portion of the first flexible arm extends along a surface of the hooking portion; wherein the at least one first flexible arm extends from the hooking portion so that the at least one first flexible arm abuts a contact surface of a caliper body and provides forces to restrain the caliper body.

One possible embodiment of the present teachings include: a disc brake assembly comprising: a support bracket; a caliper body movably attached to the support bracket via two or more pins; two or more opposing friction pads slideably attached to the support bracket, pins, body, or a combination thereof, and two or more brake springs that include: a hooking portion that securely connects the spring to the support bracket; at least one first flexible arm extending from the hooking portion and abutting a portion of a surface of the caliper body, providing a vertical force to restrain the caliper body, wherein the at least one first flexible arm reacts to the axial forces caused by the movement of the said caliper body.

One possible embodiment of the present teachings include: A disc brake assembly comprising: a support bracket; a caliper body movably attached to the support bracket; two or more opposing friction pads slidably attached to the support bracket and two or more brake springs that include: a hooking portion that securely connects the spring to the support bracket; at least one first flexible arm extending from the hooking portion and abutting a contact surface of the caliper body, providing a vertical force that is substantially normal to the contact surface of the caliper body to restrain the caliper body, the at least one first flexible arm reacts to the axial forces caused by movement of the caliper body; and one or more locking tabs on the hooking portion.

The teachings and embodiments described above may be further characterized by one or any combination of the features described herein, such as: the two or more brake springs further including one or more second flexible arms extending from the at least one first flexible arm and abutting the outer surface of the support bracket, the second flexible arm controlling the axial reaction force by limiting an axial deflection of the brake spring and providing an axial stiffness substantially independent of the contact location of the first flexible arm relative to the surface of the caliper body; the support bracket includes opposing two arm portions and there is one brake spring secured to each respective arm portion; the at least one first flexible arm has a length of less than 60 mm; the second flexible arm extends from the at least one first flexible arm within 30 mm of where the at least one first flexible arm abuts the surface of the caliper body; the vertical reaction force is from about 30 to about 150 N; the axial reaction force allows the caliper body to move axially about 0.2 mm or less before slipping on the surface of the caliper body; the two or more brake springs comprises flat spring steel; and the two or more brake springs comprises a wire.

The teachings herein surprisingly solve one or more of these problems by providing a unique brake spring design for use in a caliper assembly, a brake assembly, or both.

### BRIEF DESCRIPTION OF THE DRAWINGS

FIG. 1A illustrates a side view of a caliper assembly, used in a disc brake assembly.

FIG. 1B illustrates a close up view of FIG. 1A, an exemplary brake spring according to the present teachings.

FIG. 2A illustrates a perspective view of one exemplary brake spring according to the present teachings.

FIG. 2B illustrates a perspective view of another exemplary brake spring according to the present teachings.

FIG. 3A illustrates a perspective view of a caliper assembly, used in a disc brake assembly with yet another exemplary brake spring according to the present teachings.

FIG. 3B illustrates a side view of the assembly of FIG. 3A.

FIG. 4 illustrates a perspective view of another exemplary brake spring according to the present teachings.

FIG. 5 illustrates a side view of another exemplary brake spring attached to an arm of one possible support bracket.

FIG. 6 illustrates a perspective view of the brake spring of FIG. 5.

FIG. 7 illustrates a perspective view of one possible brake spring.

FIG. 8 illustrates a perspective view of part of a caliper assembly, used in a disc brake assembly with yet another exemplary brake spring according to the present teachings.

FIG. 9A illustrates a perspective view of an exemplary brake spring of FIG. 8 and

FIG. 9B illustrates a perspective view of another exemplary brake spring according to the present teachings.

### DETAILED DESCRIPTION

The following description of the preferred embodiment(s) is merely exemplary in nature and is in no way intended to limit the teachings, its application, or uses.

The present teachings are predicated upon providing an improved disc brake system and caliper for use with vehicles, more particularly an improved system with an improved brake spring. For example, a caliper may be used with almost any vehicle (e.g. car, truck, bus, train, airplane, or the like). Alternatively, the caliper may be integrated into assemblies used for manufacturing or other equipment that require a brake such as a lathe, winder for paper products or cloth, amusement park rides, or the like. However, the present teachings are most suitable for use with a passenger vehicle (i.e. a car, truck, sports utility vehicle, or the like).

Generally, a braking system includes a rotor, a caliper body, and a support bracket. The support bracket includes a frame member and at least two opposing arms on each side of the frame member. The arms include holes for receiving pins to support the caliper body, brake pads, or both. The caliper body includes an inboard brake pad and an outboard brake pad that are located on opposing sides of the rotor. The caliper body further includes a bridge, one or more fingers (caliper fingers), and a piston bore. The piston bore houses a piston that moves along a piston bore axis. The piston bore may include a fluid inlet, a closed wall, a front opening, a cylindrical side wall that includes an annular groove located near the front opening, and a seal in the annular groove. The support bracket may include one or more pins that assist in holding the one or more brake pads and connects to the caliper body. The brake pads may also attach directly to the arms of the support bracket. The support bracket may include two or more brake springs attached thereto (e.g., on two opposing support arms) which provide axial and radial (vertical) reaction forces between the support bracket and caliper body. The one or more brake springs may be located within the braking system so that the brake spring does not need to be moved and/or removed during maintenance to the braking system. For example, the brake pads, rotor, or both may be removed from the braking system without moving, adjusting, removing, or a combination thereof the brake springs. Maintaining the brake springs in position during maintenance reduces the chances that the brake springs may be lost, plastically deformed, fractured, bent, mis-assembled, or a combination thereof. By being able to leave the brake springs within the braking system during maintenance the life and/or forces of the brake springs may be maintained and/or not prematurely reduced by removal and subsequent replacement. The brake spring may be used with virtually any disc brake system. One type of brake systems in which the present teachings may be used with can be seen in U.S. Pat. No. 5,297,659, which is incorporated herein by reference as one alternative type of braking system.

The present teachings include a brake spring that is adapted to reduce movement of the caliper body (thus reduce rattle) as well as assist in retracting the caliper body after brake applications so that intended running clearances between the brake pads and the rotor can be maintained. The brake spring may provide an axial force, a radial force, or a force in a direction therebetween. The brake spring may counteract sag of the caliper housing due to gravity. The brake spring may have an “S” shape. The brake spring may include one or more hooking portions, one or more first flexible arms, one or more second flexible arms, one or more deformable portion on the one or more arms, one or more locking tabs, one or more lips on the one or more arms, or a combination thereof.

The hooking portion may be of any shape capable of use with a support bracket of a brake and functions to secure the brake spring to the brake. Preferably, the shape of the hooking portion of the brake spring may substantially follow or match the shape of the mating feature of the support bracket so that the hooking portion fits on the support bracket. The hooking portion may be shaped so that the hooking portion complements any feature to which it attaches. The hooking portion may be shaped so that the hooking portion matingly engages an adjacent brake component. More preferably, the shape of the hooking portion of the brake spring will be such that the brake spring fits near or abutting an outer end feature of the support bracket (i.e., an arm of the support bracket). The brake spring may include one or more hooking portions. For example, the brake spring may be made of wire and may include two hooking portions. In another example, the brake spring may be made of a sheet of material and may include only one hooking portion. The hooking portion may form a “U” shape, a “C” shape, or both. The hooking portion may be a continuously arcing part that continuously forms different radiuses over the length of the hooking portion. For example, the hooking portion may include two substantially right angle curves so that the hooking portion forms a “C” shape. The hooking portion may include a portion that folds back over itself so that a receiving area is formed, between folded portions, for receiving a component of the brake assembly (e.g., an arm of a support bracket). The hooking portion may include one or more locking tabs to aid in securely connecting or locking the hooking portion in place.

The one or more locking tabs may be any part of the brake spring that assists in connecting the brake spring to a brake component (e.g., an arm of a support bracket). The locking tab may hook into a portion of a brake component. The locking tab may extend into a recess in a brake component so that the locking tab holds the brake spring on a brake component. The locking tab may be located on a hooking portion. The locking tabs may be plastically deformable, elastically deformable, or both. The locking tab may extend from a side of the hooking portion at substantially a right angle. The locking tabs may form an angle that is between about 75 degrees and 135 degrees, preferably between about 80 degrees and about 115 degrees, and more preferably between about 85 degrees and about 105 degrees with the hooking portion, the at least one first flexible arm, or both. Preferably, when the locking tabs are located on a side of the brake spring the locking tabs are matched so that the hooking portion is supported on each side by the brake spring. The locking tabs may be symmetrically located on the brake spring, asymmetrically located on the brake spring, or both. The locking tab may be located on an edge of the hooking portion. The locking tab may be located on an end of the hooking portion. The locking tab may form a lip on the end of the hooking portion so that the hooking portion attaches to a groove of the support bracket.

The lip may enter a recess in a brake component such as a support bracket so that the lip resists the brake spring being moved along and/or removed from the brake assembly (i.e. caliper assembly). The lip may matingly engage a groove on an adjacent brake component so that the lip assists in maintaining the brake spring in contact with the adjacent brake component.

The brake spring may include at least one first flexible arm extending from the hooking portion and abutting a portion of a surface of the caliper body (i.e., a contact surface). The first flexible arm functions to provide a vertical force (i.e., along a plane parallel to the length of the fingers of the caliper, normal to the contact surface of the fingers, or both) to restrain the caliper body. The at least one first flexible arm creates a force that opposes the axial forces caused by the movement of the caliper body along the bore axis (e.g., as the brake is activated, deactivated, or both). Preferably, the forces are sufficient to aid in the retraction of the body after brake release; to maintain the caliper body parallel to the axis of the piston, the piston bore, or both; prevent rattles; or a combination thereof. In a preferred embodiment, the force (i.e., a force against a finger of the caliper body (e.g., a vertical force)) provided by the first flexible arm may range from between about 20 N to about 200 N, preferably between about 25 N to about 175 N, and more preferably between about 30 N to about 150 N (i.e., between about 75 N and about 125 N).

The brake spring force may allow the caliper body to move axially a distance before the brake spring “slips” on the surface in which it is contacting the caliper body. For example, during a brake apply, a brake retract, or both as the caliper moves, the spring may begin to move with the caliper and once the caliper moves a large enough distance the force of the spring may overcome the friction force between the brake spring and the contact surface so that the brake spring slips and the caliper moves without moving the brake spring. This may allow for the improved brake spring to maintain a nearly constant body retraction force over the useful life of the brake pads (e.g. as the pads wear), the rotor, or both. In other words, the caliper body may have a different resting position after each brake apply so that the gap between the pads and the rotor is sustainably consistent as the pads wear, the rotor wears, or both and become thinner and the brake spring “slips” to a corresponding location on the surface of the caliper body. In a preferred embodiment, the axial movement distance (before slippage) is between about 0.01 mm to about 0.5 mm, preferably between about 0.1 mm to about 0.4 mm, and more preferably less than about 0.2 mm.

The first flexible arm may be any part of the brake spring that flexes and creates a force against the caliper housing, one or more fingers, or both. The first flexible arm may be any length so that that the first flexible arm extends into contact with the caliper housing. The at least one first flexible arm may extend from the hooking portion a distance that would bring it in contact with the caliper body at a point that is less than half the distance across the caliper body (e.g., on one of the finger portions). In preferred embodiment, the length of the first flexible arm is about 150 mm or less, preferably about 100 mm or less, and more preferably about 80 mm or less (i.e., about 60 mm). The length of the first flexible arm may be at least long enough to span between the corresponding features on the support bracket and the caliper body (e.g., a length greater than zero). The first flexible arm may be substantially flat and/or planar. The first flexible arm may include a curve in a region proximate to the caliper so that the curve contacts the caliper. The first flexible arm may be folded under the hooking portion.

The first flexible arm may be attached to the hooking portion via a deformable portion. For example, brake spring may fold back upon itself at the deformable portion forming the first flexible arm. The fold (i.e., deformable portion) may create a spring like portion at one end of the first flexible arm so that the first flexible arm produces a force and is flexible. The deformable portion may be plastically deformable. Preferably, the deformable portion is elastically deformable so that the spring maintains a force on the support bracket, the caliper housing, or both. The deformable portion may allow the first flexible arm to move radially, axially, or an angle therebetween so that the brake spring prevents rattle.

The brake spring may include one or more second flexible arm. The one or more second flexible arm may be attached to the first flexible arm. The second flexible arm may extend from a side of the first flexible arm. The one or more second flexible arms may be located symmetrically, asymmetrically, or both on the first flexible arm, hooking portion, or both. The second flexible arm may form substantially a right angle with the first flexible arm. The second flexible arm may be flat. Preferably, the second flexible arm may include a contour so that the contour contacts an arm of the support bracket such that the second flexible arm is virtually always in a state of tension (i.e., is always pushing against the arm of the support bracket). The second flexible arm may assist in maintaining the brake spring's position on the brake pad during a brake apply, a brake retract, or both. For example, during a brake retract, a brake apply, or both the friction forces of first flexible arm against a finger of the caliper may move the first flexible arm with the caliper, and the second flexible arm may counteract the friction forces so that the brake spring slips against the finger and the brake spring maintains its position. The locking tabs may act as a second flexible arm and may perform one or more of the functions recited herein and preferably all of the functions. Thus, it is contemplated that the locking tabs may provide a force in the axial direction so that the brake spring's position is maintained during a brake apply, a brake retract, or both. The second flexible arm may prevent the brake spring from twisting during a brake apply, a brake retract, or any time therebetween. The second flexible arm may extend from the at least one first flexible arm and preferably abut an outer end surface of the support bracket. The second flexible arm functions to aid in controlling the axial reaction force. This may be accomplished by the second flexible arm limiting an axial deflection of the brake spring and thus providing an axial stiffness substantially independent of the contact location of the first flexible arm relative to the surface of the caliper body. The second flexible arm may limit the axial distance the flexible arm travels before slippage. The axial movement distance may be any distance recited herein.

In the case where the brake spring includes at least one second flexible arm extending from the at least one first flexible arm, the at least one second flexible arm is preferably located as close as possible to the end of the at least one first flexible arm that abuts the surface of the caliper body, but still in contact with the support bracket. In doing so, the second flexible arm may function more efficiently to aid in controlling the axial reaction force by limiting an axial deflection of the brake spring. In a preferred embodiment, the position of the second arm is within about 60 mm of where the at least one first flexible arm abuts the surface of the caliper body, more preferably within about 40 mm, and most preferably within about 30 mm, but is at least still in contact with the support bracket.

The flexible arms (i.e., the at least one first flexible arm and/or the second flexible arm); the hooking portion, the deformable portion, the locking tabs, or a combination thereof may be made of the same material. The flexible arms and hooking portion may be made of different materials and assembled together. The flexible arms may be made of any material that has springing properties. The brake spring may be made of a material that is resistant to corrosion. The brake spring may be made of any material capable of being formed. The brake spring may be made of a material that is deformable. Preferably, the brake spring may be made of metal. The brake spring may be made of titanium, aluminum, steel, copper, iron, nickel, cobalt, or a combination thereof. More preferably, the brake spring may be made of stainless steel. Even more preferably yet, the brake spring may be made of a material that has a 301 3/4H when measured by ASTM A666 or may be SU301-CSP 3/4H when measured by JIS G4313. Preferably, the brake spring is made of 301 3/4H stainless steel. Preferably, the flexible arms may be made of a material that is elastically deformable (e.g. an arm returns substantially to its original position). More preferably, the brake spring may be made of a material that is plastically deformable (e.g. a portion of the brake spring moves towards its original position but not back to its original position). The flexible arms may be made from any material configuration (i.e. sheet, roll, coil, block, molten material, liquid material, or the like). The brake spring may be formed by any known manufacturing process, such as:, casting, stamping, cutting, bending, molding, deep drawing, spinning, press brake forming, roll forming, ironing, wheeling, incremental sheet forming, decambering, or a combination thereof. Preferably, the brake spring may be made from a metallic sheet, a coil, a roll, or a combination thereof. More preferably, the flexible arms or brake spring may be made from a stainless steel sheet, coil, roll, or a combination thereof. Most preferably, every part of the brake spring may be made from one unitary piece (e.g., a formed sheet and/or wire).

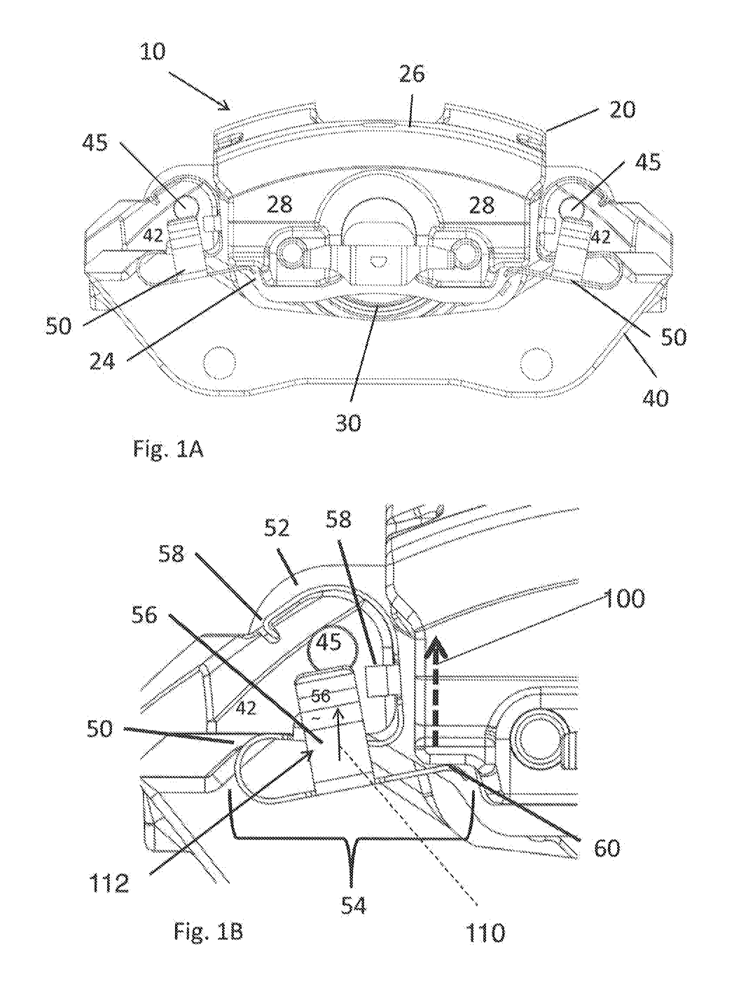

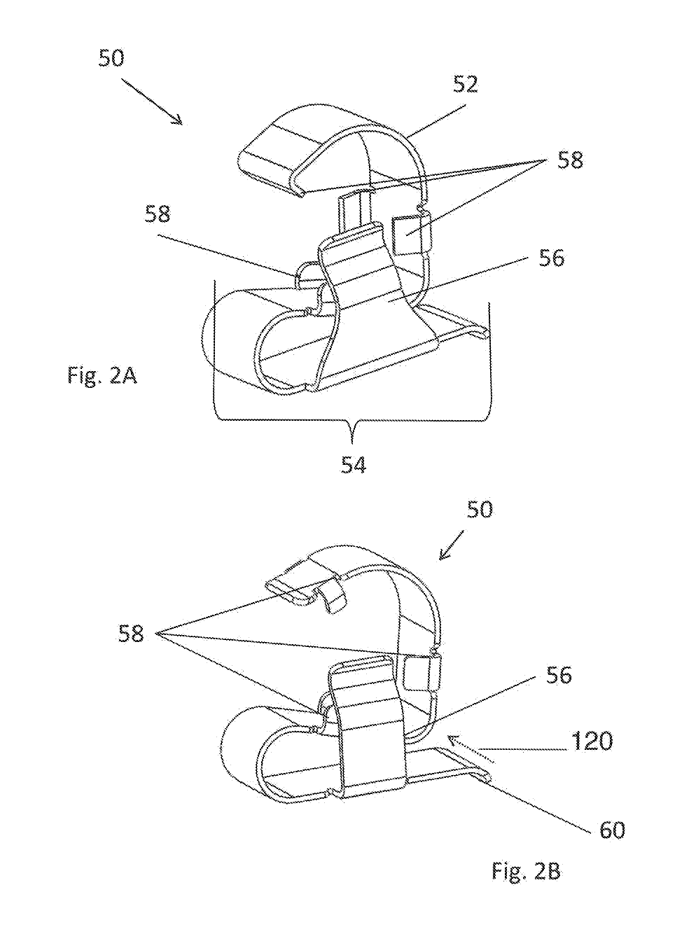

FIGS. 1A-B illustrate possible examples of a disc brake assembly 10. The disc brake assemblies 10 include a caliper body 20 and a support bracket 40. The caliper body 20 further includes an inboard brake pad 22 (not shown) and an outboard brake pad 24 that are located on opposing sides of a rotor (not shown). The caliper body 20 further includes a bridge 26, one or more fingers 28, and a piston bore 30. The piston bore includes a bore axis (not shown) along which the piston moves. The caliper body 20 slides upon pins 45 that are attached to the support bracket 40 so that the caliper body 20 slides relative to the support bracket 40, which is fixed. The pins 45 are located in the arms 42 of the support bracket 40. Also, included in these illustrative examples are one embodiment of the brake spring 50. In this example, the brake spring 50 includes a hooking portion 52, a first flexible arm 54, a second flexible arm 56, and a number of locking tabs 58, as better shown in FIGS. 1B and 2A. A force 100 (e.g., a vertical reaction force) is shown by the dashed (↑). The second flexible arm 56 creates a force 120 (e.g., an axial force) along an axis parallel to the bore axis at a region 112 of the second flexible arm 56. Also shown is the contact surface 60 of the brake spring that “slips” axially as described earlier in this disclosure, and is illustrated in FIG. 2B, as a dotted-line arrow 120, which shows the direction of the “slip.” FIGS. 2A and 2B show the brake spring 50 and the primary differences shown are examples of locking tab 58 schemes and the shape of the second flexible arm 56.

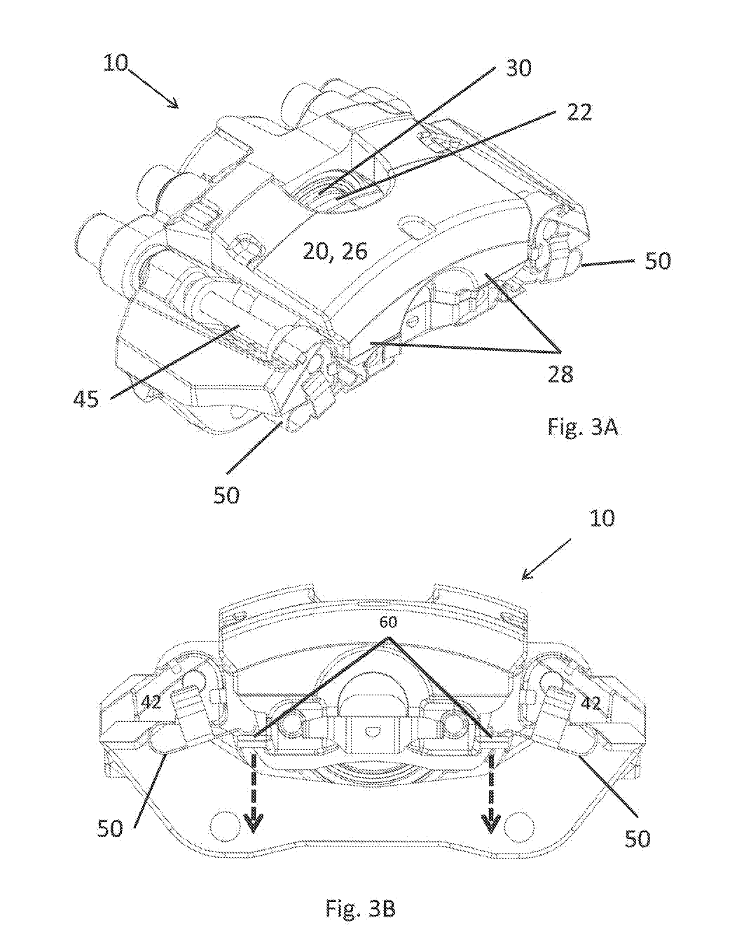

FIGS. 3A-B is another example of a disc brake assembly 10. The disc brake assembly 10 includes a variation in the caliper body 20 and specifically the fingers 28. The caliper body 20 is a two piece design with one piece being comprised of a lighter metal and a second piece being comprised of a heavier metal, and the two pieces are attached together. In this example, the force 100 is in the opposite direction compared to the first example of 1B (shown by the dashed (↑)). The body can be of unitary piece, two piece or multiple pieces joined together with any of the known joining methods such as fastening, welding, gluing, etc.

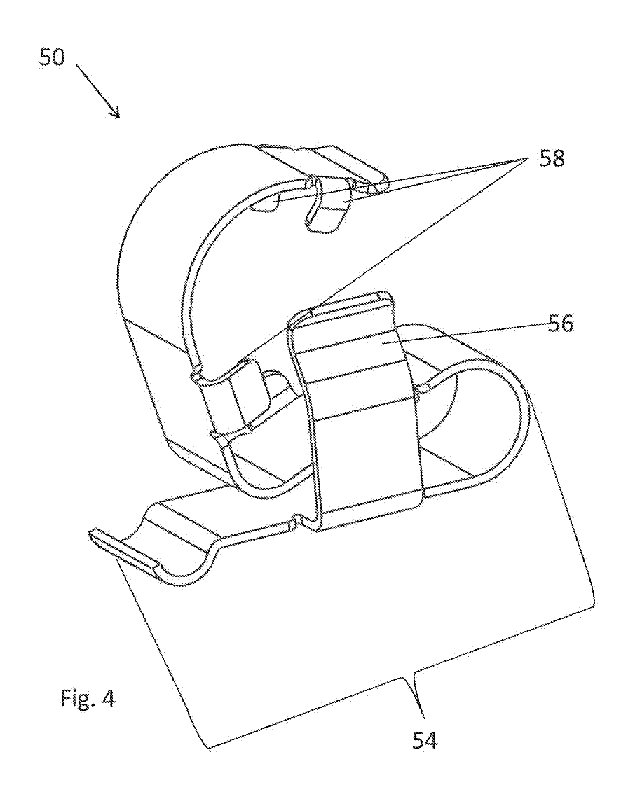

FIG. 4 shows another possible brake spring 50 not installed in the brake assembly 10. The brake spring 50 of FIG. 4 illustrates a different locking tab 58 configuration (i.e., similar to that shown in FIG. 2B). The brake spring 50 includes a first flexible arm 54 and a second flexible arm 56.

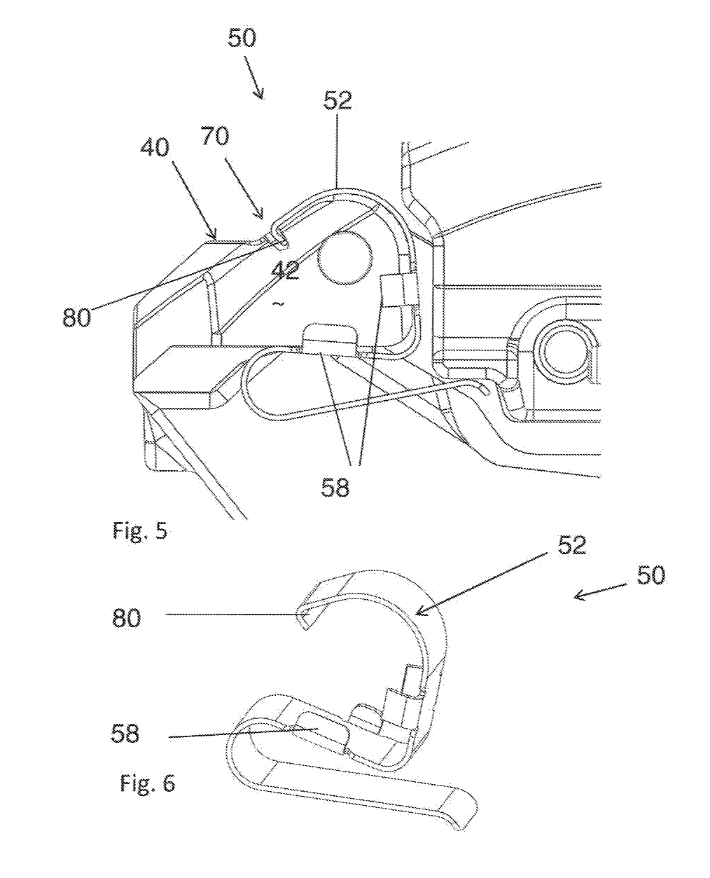

FIG. 5 illustrates a front view of one possible support bracket 40 including one possible brake spring 50 illustrated in more detail in FIG. 6. As illustrated in FIG. 5 the brake spring 50 of FIG. 6 is attached to an arm 42 of the support bracket 40. The support bracket includes a groove 70, and a lip 80 of the brake spring 50 extends into the groove 70 so that the hooking portion 52 wraps around and is attached to the arm 42 of the support bracket 40. The brake spring is attached to a support bracket 40 arm 42 via a plurality of locking tabs 58. The brake spring as illustrated does not include a second flexible arm 56.

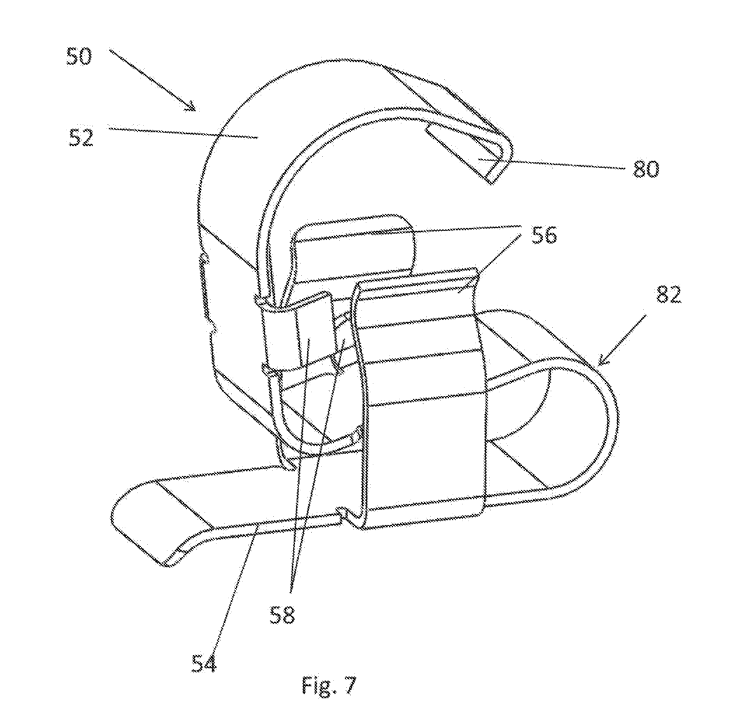

FIG. 7 illustrates another possible embodiment of the brake spring 50. The brake spring 50 includes a hooking portion 52 with a lip 80 on the end. The hooking portion 52 includes locking tabs 58. The hooking portion 52 is attached to a first flexible arm 54 via a deformable portion 82. The first flexible arm 54 includes a pair of symmetrically located second flexible arms 56.

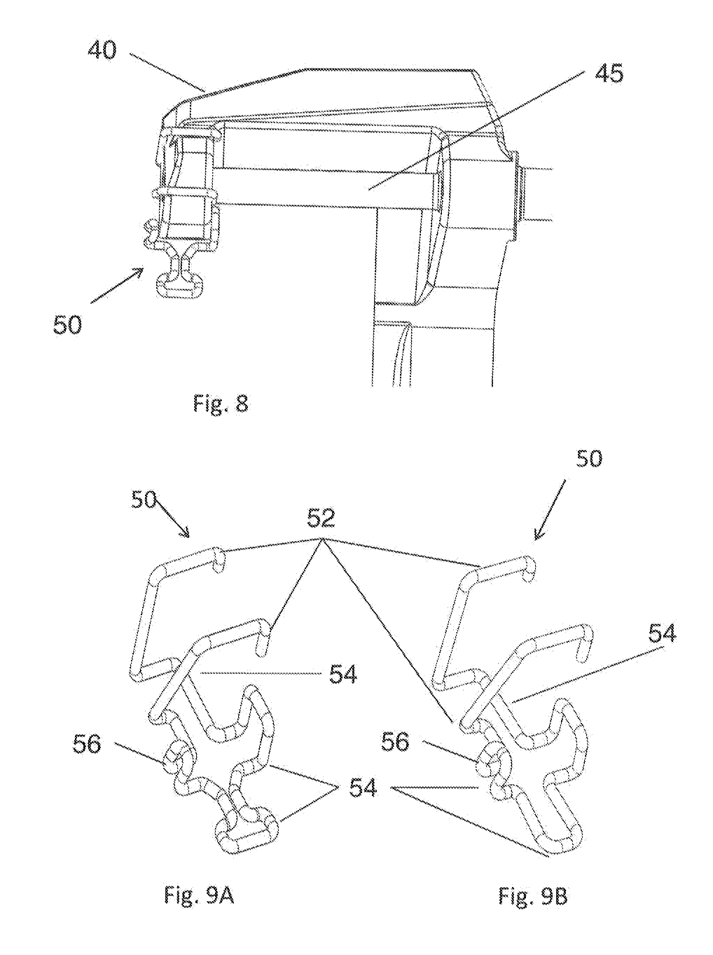

As shown in FIGS. 8 and 9A-B, a brake spring 50 comprising a wire structure is shown. The brake spring 50 of 9A-B functions in a similar fashion to those brake springs 50 presented above. FIG. 8 shows a top perspective view with the caliper body 20 and the brake pads removed to provide a clearer view of the brake spring 50 attached to the support bracket 40 and the pin 45. FIGS. 9A and 9B provide two different exemplary embodiments of the first flexible arm 54. Both FIGS. 9A and 9B include a hooking portion 52, and a second flexible arm 58.

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

What is claimed is:

1. A brake spring comprising:
a. one or more hooking portions for attaching the brake spring to an arm of a support bracket;
b. two or more locking tabs; and
c. at least one first flexible arm connected to and extending from the hooking portion,
wherein the at least one first flexible arm folds back so that at least a portion of the first flexible arm extends along a surface of the hooking portion;
wherein the at least one first flexible arm extends from the hooking portion so that the at least one first flexible arm abuts a contact surface of a caliper body and provides forces to restrain the caliper body.

2. The brake spring of claim 1, wherein one or more second flexible arms are attached to the first flexible arm and the one or more second flexible arms provide an axial stiffness to the first flexible arm that is substantially independent of the a contact surface of the at least one flexible arm so that axial deflection of the first flexible arm is limited in a direction parallel to the piston bore axis.

3. The brake spring of claim 1, wherein the brake spring is located on the arm of the support bracket so that a rotor, one or more brake pads, or both can be changed without removing the brake spring from the arm of the support bracket.

4. The brake spring of claim 1, wherein the hooking portion forms a “C” shape and the one or more locking tabs are symmetrically located on the hooking portions of the brake spring.

5. The brake spring of claim 1, wherein the brake spring includes a deformable portion between the at least one first flexible arm and the one or more hooking portions that elastically deforms providing the forces to restrain the caliper body.

6. The brake spring of claim 2, wherein the one or more second flexible arms extend from the at least one first flexible arm within 30 mm of the contact surface of the caliper body.

7. The brake spring of claim 1, wherein the first flexible arm folding back forms a spring that provides the forces to restrain the caliper body, and the force of the at least one first flexible arm restraining the caliper body is a vertical force that is substantially normal to the contact surface of the caliper body so that the vertical force restrains and limits movement of the caliper body.

8. The brake spring of claim 1, wherein the hooking portion includes a lip on an end region so that the lip matingly connects with a groove on the arm of the support bracket.

9. The brake spring of claim 1, wherein the at least one first flexible arm has a length of less than 60 mm.

10. The brake spring of claim 1, wherein the at least one first flexible arm reacts to axial forces caused by movement of the caliper body substantially along the bore axis.

11. The brake spring of claim 10, wherein the brake spring includes a second flexible arm extending from the at least one first flexible arm and the second flexible arm abuts an outer surface of the arm of the support bracket, the second flexible arm controlling the axial force caused by movement of the caliper body by limiting axial deflection of the brake spring and providing an axial stiffness substantially independent of the contact location of the first flexible arm relative to the surface of the caliper suspended body.

12. The brake spring of claim 7, wherein the vertical force is from about 30 to about 150 N.

13. The brake spring of claim 11, wherein an axial reaction force of the brake spring allows the caliper body to move axially about 0.2 mm or less before slipping on the surface of the caliper body occurs.

14. The brake spring of claim 13, wherein the brake spring is made from flat spring steel.

15. The brake spring of claim 13, wherein the brake spring is made from a wire.

16. A disc brake assembly comprising:
a) a support bracket;
b) a caliper body movably attached to the support bracket;
c) two or more opposing friction pads slidably attached to the support bracket and
d) two or more brake springs that include:
i. a hooking portion that securely connects the spring to the support bracket;
ii. at least one first flexible arm extending from the hooking portion and abutting a contact surface of the caliper body, providing a vertical force that is substantially normal to the contact surface of the caliper body to restrain the caliper body, the at least one first flexible arm reacts to the axial forces caused by movement of the caliper body; and
iii. one or more locking tabs on the hooking portion.

17. The disc brake assembly of claim 16, wherein the two or more brake springs have a second flexible arm extending from the at least one first flexible arm and abutting an outer surface of the support bracket, the second flexible arm controlling an axial force by limiting the axial deflection of the first flexible arm of brake spring in being a direction parallel to the piston bore axis and providing an axial stiffness substantially independent of the contact location of the first flexible arm relative to the surface of the caliper suspended body.

18. The disc brake assembly of claim 16, wherein the support bracket includes two opposing arms and there is one brake spring secured to each respective arm of the support bracket.

19. The disc brake assembly of claim 16, wherein the brake spring remains connected to the support bracket during replacement of one or more brake pads, a rotor, or both.

20. The disc brake assembly of claim 19, wherein the at least one first flexible arm has a length of less than 60 mm;
wherein the second flexible arm extends from the at least one first flexible arm within 30 mm of where the at least one first flexible arm abuts the surface of the caliper body;
wherein the vertical reaction force is from about 30 N to about 150 N; and
wherein the axial reaction force allows the caliper suspended body to move axially about 0.2 mm or less before slipping on the surface of the caliper suspended body.
